(19) United States
(12) Patent Application Publication
(10) Pub. No.: US 2004/0104835 A1
(43) Pub. Date: Jun. 3, 2004

(54) MICROWAVE ABSORBENT DEVICES AND MATERIALS

(76) Inventor: Takeyuki Ojima, Tokyo (JP)

Correspondence Address: ROBERT E MALM, 16624 PEQUENO PLACE, PACIFIC PALISADES, CA, 90272

(21) Appl. No.: 10/605,026

(22) Filed: Sep. 2, 2003

Related U.S. Application Data
(60) Provisional application No. 60/417,037, filed on Oct. 9, 2002.

(51) Int. Cl. H01Q 17/00

(52) U.S. Cl. 342/1; 342/4

(57) ABSTRACT

A composite dielectric in which particles having a volume resistivity of between 2 ohms-cm and 2 mega-ohms-cm are dispersed. This composite dielectric is much more dissipative for electromagnetic fields in the microwave-frequency region than a conventional one wherein highly-conductive particles are dispersed.

### CROSS REFERENCE TO RELATED APPLICATIONS

This application claims the benefit of U.S. Provisional Application No. 60/417,037, filed Oct. 09, 2002.

### BACKGROUND OF INVENTION

This invention relates generally to microwave absorbing devices and materials and more particularly to devices and materials involving a non-conductive matrix wherein particles of moderate conductivity are dispersed.

The losses associated with lossy dielectrics are generally frequency-dependent and have a frequency characteristic of Debye's dispersion. In the past, composite dielectrics for use as electromagnetic-wave absorbers have been mainly composed of a chemical matrix and highly conductive particles of materials such as carbon, graphite and various metals with conductivities greater than about 100 S/m (siemens per meter) which is equivalent to a volume resistivity of 1 ohm-cm.

Loss factor (i.e. loss-tangent) of a composite dielectric in which such highly conductive particles are dispersed reaches its maximum at millimeter-wavelength frequencies or higher. The loss factor rapidly decreases from its peak value as the frequency decreases. As a result, large loss factors for this type of composite dielectric are not achievable in the microwave region (i.e. centimeter-wavelength region).

### BRIEF DESCRIPTION OF DRAWINGS

FIG. 1 is a graph of loss factor of a lossy dielectric composed of a chemical matrix and conductive particles dispersed uniformly therein as a function of frequency normalized with respect to the peak frequency at which the imaginary part of the dielectric constant of the lossy dielectric is a maximum.

FIG. 2 is a graph of peak frequency as a function of a particle's conductivity divided by the real dielectric constant of the chemical matrix.

### DETAILED DESCRIPTION

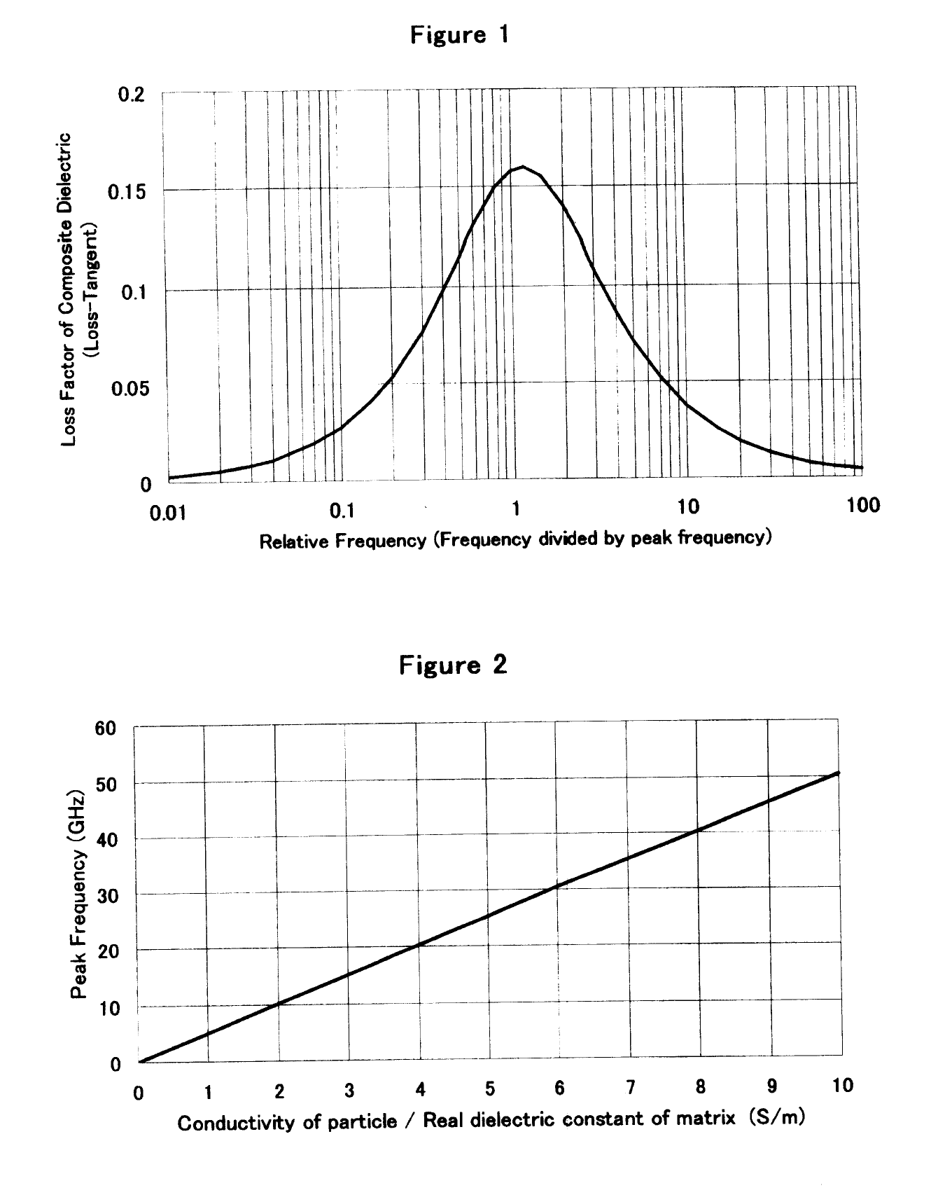

FIG. 1 is a graph of loss factor of a lossy dielectric composed of a chemical matrix and conductive particles dispersed uniformly therein. The loss factor is plotted against frequency normalized with respect to the peak frequency which is the frequency at which the imaginary part of the dielectric constant of the lossy dielectric (i.e. the loss term) becomes a maximum. In FIG. 1, the peak frequency corresponds to a normalized frequency of 1. The actual value of the peak frequency is shown in FIG. 2.

The peak frequency is generally very close to the frequency at which the loss factor is maximum as can be seen in FIG. 1. And the peak frequency is inherent to a composite dielectric.

The loss factor in FIG. 1 was computed for a volumetric mixing ratio of 12.5 percent, and it increases proportionately with increase of the mixing ratio until reaching saturation. The shape of the curve remains almost unchanged with different mixing ratios.

As can be seen in FIG. 1, the amount of loss factor at a specified normalized frequency is primarily determined by the difference of the normalized frequency and 1. FIG. 1 shows that for a normalized frequency of 0.2, the loss factor is less than one-third of its peak value.

Therefore, in order to get a large loss factor in a microwave region, it is necessary to bring the peak frequency of a composite dielectric into the microwave region.

FIG. 2 is a graph of peak frequency computed as a function of particle's conductivity divided by the real dielectric constant of the chemical matrix. The mixing ratio has only a slight effect on the peak frequency and need not be of any particular concern in creating a lossy dielectric. Available chemical substances such as plastics that are useable for a matrix have a real dielectric constant of between 2 and 10. Thus, when using highly conductive particles with more than 100 S/m of conductivity as is the current practice, the conductivity divided by real dielectric constant is more than 10, which corresponds to a peak frequency greater than 50 GHz, as shown in FIG. 2.

Therefore, in order to make peak frequency less than 30 GHz in the microwave region, the ratio of particle conductivity to the real dielectric constant of the matrix must be less than 6, as shown in FIG. 2. And the conductivity of particles to be mixed into an available matrix must be less than about 50 S/m for obtaining a high-loss dielectric in the microwave region.

Additionally, the conductivity of the conductive particles must be greater than 0.05 millisiemens per meter which corresponds to the volume resistivity of 2 megohms-cm if the conductive particles are to be distinguishable from particles of an insulator.

1. A microwave absorbing device in the form of a solid body and made of a composite material comprising a non-conductive matrix wherein conductive particles are dispersed, the conductive particles having a volume resistivity greater than about 2 ohms-cm.

2. The microwave absorbing device of claim 1 wherein the conductive particles are non-magnetic.

3. The microwave absorbing device of claim 1 wherein the volume resistivity of the conductive particles are less than about 2 megohms-cm.

4. The microwave absorbing device of claim 1 wherein the conductive particles are non-magnetic and the volume resistivity of the conductive particles are less than about 2 megohms-cm.

5. A composite material comprising a non-conductive matrix wherein conductive particles are dispersed, the conductive particles having a volume resistivity greater than about 2 ohms-cm.

6. The composite material of claim 5 wherein the conductive particles are non-magnetic.

7. The composite material of claim 5 wherein the volume resistivity of the conductive particles are less than about 2 megohms-cm.

8. The composite material of claim 7 wherein the conductive particles are non-magnetic and the volume resistivity of the conductive particles are less than about 2 megohms-cm.

9. The composite material of claim 7 wherein some or all of the conductive particles are of a material from the group consisting of a semiconductor, a polymer, and carbon black.

10. The composite material of claim 7 wherein some or all of the conductive particles are conductive polymer particles.

11. The composite material of claim 7 wherein some or all of the conductive particles are of a material from the group consisting of silicon, germanium, a gallium compound, and an indium compound.
